(19) United States
(12) Patent Application Publication
(10) Pub. No.: US 2006/0068251 A1
(43) Pub. Date: Mar. 30, 2006

(54) Fuel cell device for computer systems

(76) Inventors: Rajiv K. Mongia, Portland, OR (US); Eric DiStefano, Livermore, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,761

(22) Filed: Sep. 29, 2004

(51) Int. Cl. H01M 8/04; H01M 2/02

(52) U.S. Cl. 429/26; 429/34

(57) ABSTRACT

A fuel cell module for powering a computer system is described. Specifically, the fuel cell module may comprise a fuel cell stack, fuel storage unit, and a thermal management unit. Electricity to power the computer system is generated by the fuel cell stack. The fuel storage unit supplies the fuel for the fuel cell stack. The thermal management unit is used to monitor and remove heat and water byproducts generated by the fuel cell stack.

### FIELD OF THE INVENTION

The present invention pertains to the field of computer system design. More particularly, the present invention relates to a fuel cell device that enables mobile computing for longer periods of time without having to recharge a power source.

### BACKGROUND OF THE INVENTION

A fuel cell converts chemical energy to electrical energy through an electrochemical reaction. Air and a fuel are typically combined to generate the electrochemical reaction. Aside from electricity, the air and fuel mixture may also produce other byproducts, such as heat and water.

A fuel cell typically comprises a fuel cell stack. The fuel cell stack is a plurality of connected individuals cells. Each cell in the fuel cell stack has a positive electrode and a negative electrode. The reactions that produce electricity take place at the electrodes. An electrolyte in the fuel cell carries electrically charged particles from one electrode to another.

### BRIEF DESCRIPTION OF THE DRAWINGS

FIG. 1A is an embodiment of a fuel cell module having a thermal management system.

FIG. 1B is another embodiment of a fuel cell module having a thermal management system.

FIG. 2 is an embodiment of a computer system having a fuel cell module.

FIG. 3 is an embodiment of a computer system powered by a fuel cell module.

FIG. 4 is a flowchart of power generation in an electronic system.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

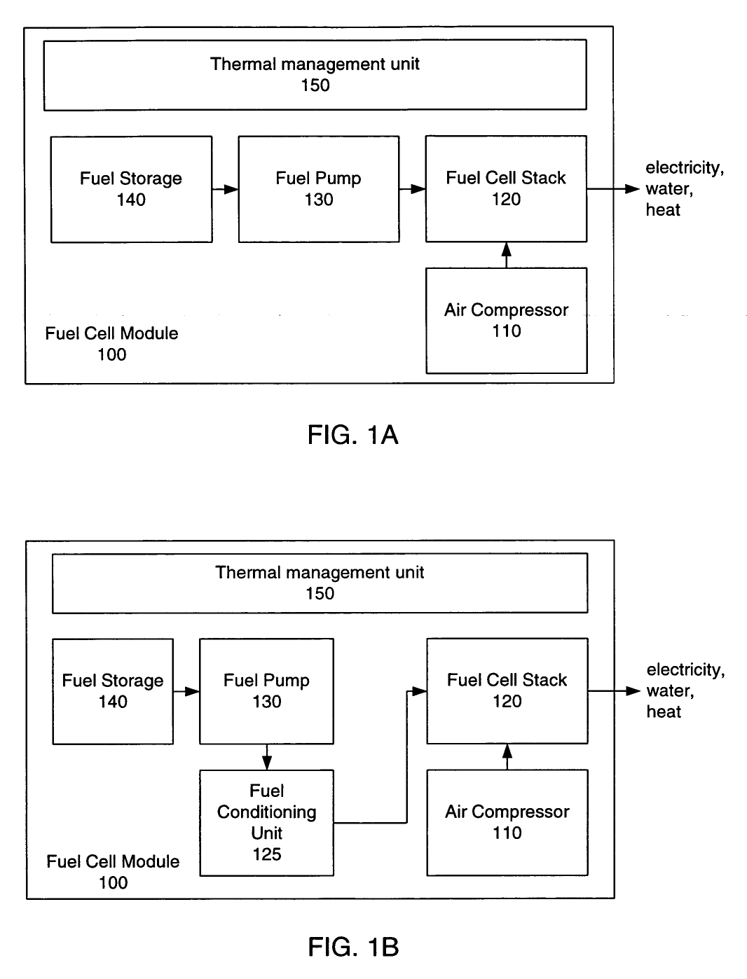

A fuel cell module that is integrated into an electronic device may increase the time the electronic device may be used without having to recharge the electronic device's power supply. For one embodiment of the invention, FIG. 1A depicts a fuel cell module 100 that powers electronic devices. The fuel cell module 100 comprises an air compressor 110, fuel cell stack 120, fuel pump 130, fuel storage 140, and thermal management unit 150. Fuel cell stack 120 is coupled to air compressor 110 and fuel pump 130. Fuel pump 130 is coupled to fuel storage 140. Fuel cell stack 120 thermally maintains the fuel cell module 100.

The air compressor 110 may transfer ambient air to the fuel cell stack 120. Ambient air may be available to the air compressor 110 through a vent in the electronic device or fuel cell module 100. In addition to receiving air, the fuel cell stack 120 may also receive a fuel input. The fuel may be a hydrocarbon fuel. For example, the fuel may be natural gas, methanol, ethanol, butane, or propane. Alternatively, the fuel may be of another type such as hydrogen. The fuel may be stored in fuel storage 140. The fuel storage 140 in the fuel cell module 100 may be refueled or recharged, or replaced. A fuel pump 130 may deliver the fuel from the fuel storage 140 to the fuel cell stack 120. However, the fuel pump 130 may not be required if the fuel is pressurized.

FIG. 1B depicts another embodiment of a fuel cell module 100 that powers electronic devices. The fuel cell module 100 comprises an air compressor 110, fuel cell stack 120, fuel conditioning unit 125, fuel pump 130, fuel storage 140, and thermal management unit 150. Fuel cell stack 120 is coupled to air compressor 110 and fuel conditioning unit 125. Fuel conditioning unit 125 is coupled to fuel pump 130. Fuel pump 130 is coupled to fuel storage 140. Fuel cell stack 120 maintains the temperature of fuel cell module 100.

The air compressor 110 may transfer ambient air to the fuel cell stack 120. The fuel cell stack 120 may also receive a fuel input from fuel conditioning unit 125. The fuel may be stored in fuel storage 140. A fuel pump 130 may deliver the fuel from the fuel storage 140 to the fuel conditioning unit 125. For another embodiment of the invention, the fuel pump 130 may be omitted from the fuel cell module 100 if the fuel is pressurized.

The fuel conditioning unit may extract hydrogen from the fuel. The fuel conditioning unit 125 may comprise a reforming technology such as steam reforming, partial oxidation reforming, or auto-thermal reforming.

Alternatively, the fuel stored in the fuel storage 140 may be compressed, liquefied hydrogen or adsorbed hydrogen. Reforming is not required if hydrogen is provided directly from fuel storage 140 or if the fuel cell is configured to work directly from the fuel such as methanol. The fuel cell module 100 of FIG. 1A may be implemented if a fuel conditioning unit 125 is unnecessary.

The fuel cell stack 140 mixes hydrogen with air. The electrochemical reaction of the combination may generate electricity, heat, and water. The electricity may be used to power the electronic device of which the fuel cell module 100 is integrated. A thermal management unit 150 may be used to remove heat from the fuel cell module 100.

Further, to prevent water from being generated by the fuel cell stack 140, the thermal management unit 150 may monitor the temperature of the fuel cell stack 140 or other components of the fuel cell module 100 to keep the temperature above the dew point. The thermal management unit 150 may comprise a processor, a sensor and a fan. If the sensor detects a temperature above a predetermined threshold, the processor may enable the fan until the temperature in the fuel cell module 100 is decreased.

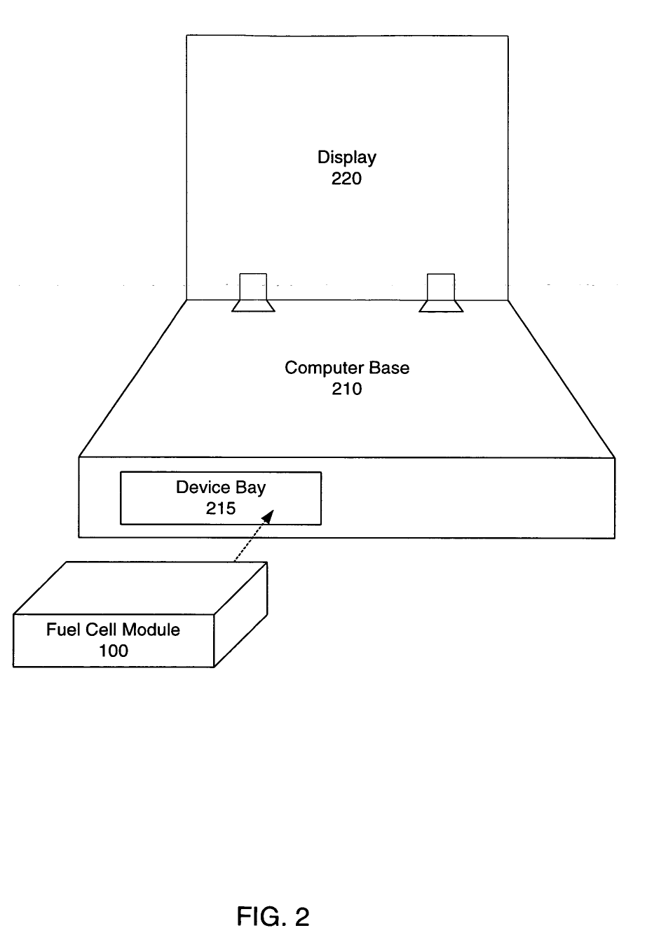

For one embodiment of the invention, the electronic device of having an integrated fuel cell module 100 may be a mobile computer. FIG. 2 depicts a mobile computer having a computer base 210 and a display 220. The computer base 210 has a device bay 215. The device bay 215 may be a battery bay or an optical drive bay. A lithium battery may be inserted into the device bay 215 to power the mobile computer. For this embodiment of the invention, the fuel cell module 100 may have approximately the same dimensions as the lithium battery. Thus, the fuel cell module 100 may be used to power the mobile computer instead of the lithium battery. The fuel cell module 100 may be inserted directly into the device bay 215 of the computer base 210.

The fuel cell module 100 may be removed from the device bay 215. The entire fuel cell module 100 may be taken out and replaced if the fuel stored in the fuel storage 140 is low. Alternatively, the fuel cell module 100 may be designed to allow the fuel storage 140 to be refueled directly or to be taken out and replaced with a full fuel storage.

For another embodiment of the invention, the electronic device having an integrated fuel cell module 100 may be a cellular phone. For yet another embodiment of the invention, the electronic device having an integrated fuel cell module 100 may be an mp3 player. For yet another embodiment of the invention, the electronic device having an integrated fuel cell module 100 may be an electronic calendar organizer.

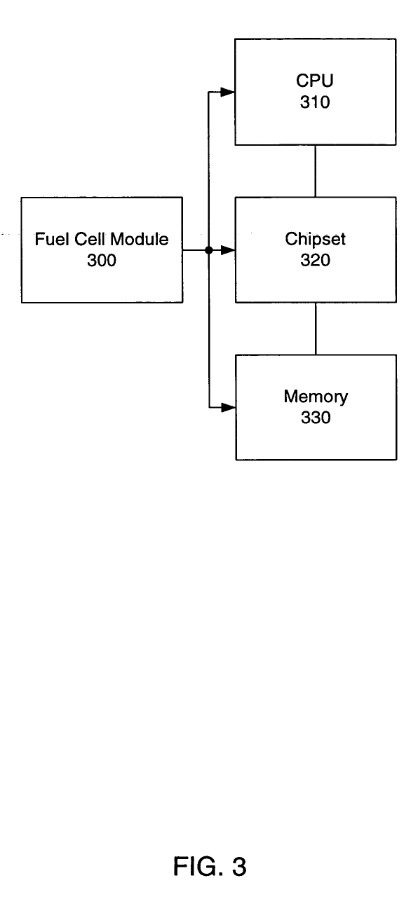

FIG. 3 depicts a computer system powered by a fuel cell module 300. Fuel cell module 300 is coupled to a CPU 310, a chipset 320, and a memory 330. Fuel cell module 300 generates power from an electrochemical reaction. The power is then distributed and used to power CPU 310, chipset 320, and memory 330. The chipset 320 may transfer data between CPU 310 and memory 330. For one embodiment of the invention, fuel cell module 300 comprises an internal thermal management unit to remove heat from the fuel cell module 300 such that the fuel cell module 300 does not thermally impact the rest of the computer system. The computer system may comprise a cooling loop to further purge the heat from the computer system.

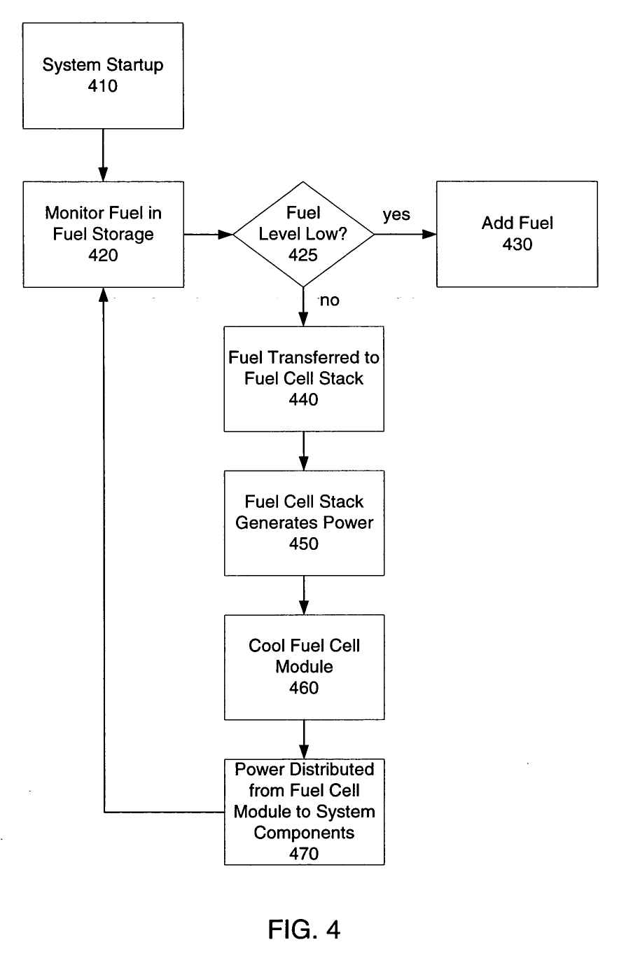

FIG. 4 depicts a flowchart for the operation of an embodiment of a fuel cell module that powers an electronic system. In operation 410, the system is powered up. The system then begins to monitor the fuel level of the fuel cell module's fuel storage in operation 420. Monitoring of the fuel level may be performed by a processor of the electronic system or the fuel cell module itself. If the fuel level is determined to be low in operation 425, fuel is added to the fuel storage in operation 430. Fuel may be directly added to the fuel storage. For example, a user of the electronic system may manually add the fuel to the fuel storage. Alternatively, the empty fuel storage may be replaced by a full fuel storage.

If the fuel level is not detected to be low in operation 425, fuel is transferred to the fuel cell stack in operation 440. The electrochemical reaction in the fuel cell stack, caused by the mixture between fuel and air, generates electricity in operation 450. A byproduct of the electrochemical reaction may be heat. The fuel cell module is cooled in operation 460. The fuel cell module may comprise a thermal management unit to dissipate the generated heat.

The electricity generated by the fuel cell module is distributed to components of the electronic system in operation 470. The electricity is used to power the components of the electronic system. The system then returns to operation 420 in order to continuously monitor the fuel in the fuel storage.

For another embodiment of the invention, operations 440, 450, 460, and 470 may be combined into a single operation.

In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense.

What is claimed is:

1. An electronic device, comprising:
a processor; and
a fuel cell module coupled to the processor to supply power to the processor, wherein the fuel cell module has a thermal management unit that removes heat from the fuel cell module.

2. The electronic device of claim 1, wherein the thermal management unit ensures that the fuel cell module does not have a thermal impact on the remainder of the electronic device.

3. The electronic device of claim 1, wherein the thermal management unit keeps a temperature of the fuel cell module above a dew point.

4. The electronic device of claim 3, wherein the temperature of the fuel cell module is monitored by the processor.

5. The electronic device of claim 3, wherein the temperature of the fuel cell module is monitored by the thermal management unit.

6. The electronic device of claim 1, wherein the fuel cell module is positioned in a device bay of the electronic device.

7. The electronic device of claim 1, wherein the fuel cell module is positioned in an optical drive bay of the electronic device.

8. The electronic device of claim 1, wherein the electronic device is a mobile computer.

9. The electronic device of claim 1, wherein the electronic device is a mp3 player.

10. The electronic device of claim 1, wherein the electronic device is a cellular phone.

11. A computer system, comprising:
means for generating power in a computer system;
means for cooling a fuel cell module; and
means for positioning the fuel cell module in a device bay of the computer system.

12. The computer system of claim 11, further comprising:
means for replacing the fuel cell module.

13. The computer system of claim 11, further comprising:
means for adding fuel to the fuel cell module.

14. The computer system of claim 11, further comprising:
means for monitoring a temperature of the fuel cell module.

15. A method, comprising:
monitoring fuel in a fuel storage of a fuel cell module, wherein the fuel cell module is part of a computer system;
transferring fuel from the fuel storage to a fuel cell stack;
generating electricity in the fuel cell stack; and
cooling the fuel cell module with a thermal management unit in the fuel cell module.

16. The method of claim 15, further comprising:
distributing the electricity generated in the fuel cell stack to a processor of the computer system.

17. The method of claim 15, further comprising:
transferring the heat away from the fuel cell module.

18. A fuel cell module, comprising:
a fuel cell stack to generate power in a computer system;
a fuel storage coupled to the fuel cell stack to store fuel; and
a thermal management unit coupled to the fuel cell stack to remove heat from the fuel cell module.

19. The fuel cell module of claim 18, further comprising:
a fuel pump coupled to the fuel cell stack and the fuel storage to transfer fuel from the fuel storage to the fuel cell stack.

20. The fuel cell module of claim 18, further comprising:
an air compressor coupled to the fuel cell stack to transfer ambient air to the fuel cell stack.

21. The fuel cell module of claim 18, further comprising:
a fuel conditioning unit coupled to the fuel cell stack to extract hydrogen from the fuel.

22. The fuel cell module of claim 18, wherein the fuel stored in the fuel storage is a hydrocarbon fuel.

23. The fuel cell module of claim 18, wherein natural gas is stored in the fuel storage.

24. The fuel cell module of claim 18, wherein ethanol is stored in the fuel storage.

25. The fuel cell module of claim 18, wherein methanol is stored in the fuel storage.

26. The fuel cell module of claim 18, wherein butane is stored in the fuel storage.

27. The fuel cell module of claim 18, wherein propane is stored in the fuel storage.
